(19) United States
(12) Patent Application Publication
(10) Pub. No.: US 2013/0082196 A1
(43) Pub. Date: Apr. 4, 2013

(54) COMPACT MODULAR PARTICLE FACILITY HAVING LAYERED BARRIERS

(71) Applicant: Veritas Medical Solutions LLC, Malvern, PA (US)

(72) Inventor: David P. Farrell, Gilbertsville, PA (US)

(73) Assignee: Veritas Medical Solutions LLC, Malvern, PA (US)

(21) Appl. No.: 13/678,841

(22) Filed: Nov. 16, 2012

Related U.S. Application Data
(63) Continuation of application No. PCT/US2011/036934, filed on May 18, 2011.
(60) Provisional application No. 61/345,773, filed on May 18, 2010.
(60) Provisional application No. 61/417,666, filed on Nov. 29, 2010.

(51) Int. Cl. G21F 7/00

(52) U.S. Cl. CPC G21F 7/00
USPC 250/496.1; 250/506.1

(57) ABSTRACT

A layered barrier for a compact particle facility is provided; the layered barrier includes a first layer formed from first shielding elements and a second layer formed from second shielding elements. The first and second shielding elements are modular and have different shielding characteristics from one another.

### CROSS REFERENCE TO RELATED APPLICATIONS

This application is a continuation of International Patent Appln. No. PCT/US2011/036934, filed May 18, 2011, which claims the benefit of U.S. Provisional Application Ser. No. 61/345,773, filed May 18, 2010, and U.S. Provisional Application Ser. No. 61/417,666, filed Nov. 29, 2010, which are incorporated by reference as if fully set forth herein.

### FIELD OF INVENTION

This application is generally related to particle facilities structures and more particularly related to a layered barrier for a compact particle research or treatment facility.

### BACKGROUND

Particle facilities are used in many applications, such as for research or medical treatment. Radiation from the use of protons, neutrons, X-rays or other particles must be shielded, and as such, these facilities must be designed and constructed to provide adequate attenuation of the various radiations and intensities to prevent exposure to people outside of the facility. Radiation levels both inside and outside of a particle facility must also comply with appropriate federal and state regulations. Known particle facilities are generally constructed as a room housing the source of radiation, with concrete walls, ceilings, and floors that can have a thicknesses of 8 to 20 feet or more. In addition, a maze entry is usually used to provide a wing wall to capture scatter radiation and/or multiple turns of the maze to reduce the radiation intensity reaching the entrance to the treatment room to safe levels. The entrance to a maze entry particle facility may also include a shielded door to further prevent radiation leakage to the outside of the room. These traditional particle facilities have numerous disadvantages. Traditional shielding walls generally consist of a homogeneous concrete mixture and are formed in place through a continuous pour operation, which increases construction cost, time, and scheduling difficulties. The use of extremely thick concrete walls adds to the particle facility's large footprint, decreases the amount of useable space within the facility, and does not allow for easy repair or modification of the resulting structure. The need for a maze entry further adds to the particle facility's large foot print. Where the particle facility is a medical treatment facility such as a radiation therapy room, the presence of thick concrete walls and/or a maze entry can intimidate patients entering the treatment facility. In addition, the use of concrete can lead to shielding density or other property variations in the shielding walls, deterioration over time, and incomplete capture of particles and particle byproducts.

Secondary neutron radiation is the predominate shielding problem in a proton or other particle facility. The average neutron energy and fluence can vary with changes in angle but the maximum energy of the neutron that results from a 230 MeV proton beam for 0 degrees is on the order of the proton energy or 230 MeV. As the neutron travels through a shield and interacts with various materials, the average energy is degraded and different materials become more or less effective at slowing the neutron. As such, a make up of different materials to attenuate and capture the neutron and bi-product radiations would be desirable. Typically, the use of a homogenous material, such as concrete, has been used but is somewhat inefficient in its attenuating properties as the average neutron energy changes.

A need exists for a compact particle facility having shielding barriers, such as walls and ceilings, that are modular (dry stackable interlocking), simple to construct, provide adequate shielding, reduce the facility's footprint, allow for easy expansion or configuration, can eliminate the need for a maze entry, and can be sufficiently tailored to attenuate and capture the type of particles that require attenuation in the particle facility.

### SUMMARY

A layered barrier for a compact particle facility is disclosed. The layered barrier includes a first layer formed from first shielding elements and a second layer formed from second shielding elements. The first and second shielding elements are modular and have different shielding characteristics from one another.

A compact particle facility is also disclosed. The compact particle facility includes a room having a plurality of layered barriers that define an interior area that is directly accessible through a shielded door located in one of the plurality of layered barriers. Each one of the plurality of layered barriers is formed from modular shielding elements.

An alternate embodiment of a compact particle facility is also disclosed. The compact particle facility includes a source room and at least one patient room. The source and the at least one patient room each includes a plurality of layered barriers that define an interior area that is directly accessible through a shielded door located in one of the plurality of layered barriers. Each one of the plurality of layered barriers is formed from modular shielding elements. The source room contains a radiation source, and radiation from the radiation source is directed into the at least one patient room through a wave guide.

For sake of brevity, this summary does not list all aspects of the present device, which are described in further detail below and in the appended claims.

### BRIEF DESCRIPTION OF THE DRAWINGS

The foregoing summary, as well as the following detailed description of the preferred embodiments, will be better understood when read in conjunction with the appended drawings. For the purpose of illustrating the invention, there is shown in the drawings embodiments which are presently preferred. It should be understood, however, that the invention is not limited to the precise arrangement shown.

FIG. 1 is a top plan view of a traditional maze entry particle facility.

FIG. 2 is a top plan view of a compact particle facility constructed using an embodiment of the layered barrier and having a maze entry.

FIG. 3 is a top plan view of a compact particle facility constructed using an embodiment of the layered barrier and having a direct entry.

FIG. 4 is a top plan view of a compact particle facility constructed using an embodiment of the layered barrier, and having a source room and a plurality of patient rooms.

FIG. 5 is a fragmentary perspective view of the compact particle facility shown in FIG. 4.

FIG. 6 is a comparative perspective view of a particle treatment room constructed using an embodiment of the layered barrier and a particle treatment room constructed using concrete barriers.

FIG. 7 is another comparative perspective view of a particle treatment room constructed using an embodiment of the layered barrier and a particle treatment room constructed using concrete barriers.

FIG. 8 is a perspective view of a partially constructed layered barrier.

FIG. 9 is a perspective view of a modular shielding element used to construct the layered barrier shown in FIG. 8.

FIGS. 10A-10D illustrate how the present layered barrier attenuates and/or captures particles at different energy levels.

FIG. 11 is a graph illustrating attenuation length comparisons of different materials at various angles.

FIG. 12 is a graph illustrating attenuation length comparisons of different materials at various neutron energy levels.

FIG. 13 is a graph illustrating percent neutron dose attenuation of different materials at various depths.

FIG. 14 is another graph illustrating percent neutron dose attenuation of different materials at various depth.

### DETAILED DESCRIPTION OF THE PREFERRED EMBODIMENTS

Certain terminology is used in the following description for convenience only and is not limiting. The words “inner,” “outer,” “upper,” “lower,” “top,” and “bottom” designate directions in the drawings to which reference is made. Additionally, the terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

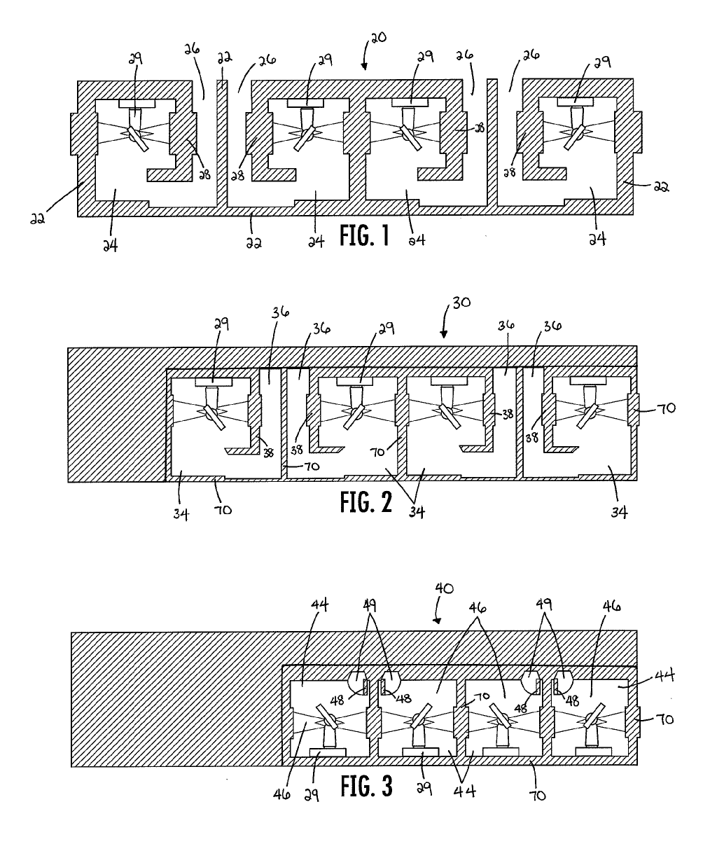

FIG. 1 shows a traditional maze entry particle facility 20 constructed from traditional concrete barriers 22 and having a plurality of separate rooms 24. Each room 24 includes a maze entry 26 that provides a wing wall 28 to capture scatter radiation from a radiation source 29. Although not shown in FIG. 1, the entrance to each maze entry 26 can include a shielded door to further prevent radiation leakage to the outside of the room 24. The walls, ceilings, and floors of each room 24 is usually constructed from concrete and of sufficient density and thickness to shield electromagnetic radiation, including, without limitation, photon, gamma, neutron, and proton radiation.

In traditional particle facilities, the walls, ceiling, and floor are generally formed from a homogeneous concrete mixture through a continuous pour operation. These concrete shielding walls must be sufficiently thick to ensure adequate shielding, and generally range from 8 to 20 feet. The thicknesses of these concrete shielding walls also vary depending on the type of radiation used in the particle facility, such as photon, gamma, neutron, and proton radiation. In traditional concrete wall particle facilities, thicker concrete wall are typically formed in areas having high radiation leakage.

There are significant cost and logistic disadvantages to using continuously poured concrete shielding walls. First, forming concrete shielding walls of sufficient thicknesses requires large amounts of concrete and complicated pouring schedules, which increases the cost and time of construction. There are additional problems associated with pouring concrete in inclement weather, which can further affect construction schedules. The heat and hydrostatic pressure from mass concrete pours also result in hydration problems and the need for specialty forms. The heat of hydration results from the exothermic chemical reaction when cement is mixed with water. When forming large concrete structures, this heat of hydration cannot be readily released, and the concrete mass may attain high internal temperatures, especially during hot weather construction. These high internal temperatures can cause undesired expansion as the concrete hardens, and when the concrete undergoes non-uniform or rapid cooling, stresses from thermal contraction can result in cracking before or after the concrete cools to the surrounding temperature. Various construction practices are used to address these problems, such as adjusting mixing and placing temperatures based on the ambient temperature, controlling mixing and placing procedures to minimize delays, and using the cooler parts of the day for placing operations. However, all of these practices increases the complexity, time, and cost of construction. In addition, the resulting concrete shielding walls may contain shielding density variations, structural and curing problems, and the like, that result from inconsistencies during the pouring process. The type of particles used in a particle facility often dictates the thickness of the concrete shielding walls. Therefore, once a particle facility having concrete shielding walls has been constructed, it cannot be modified for a different type of particle treatment without significant reconstruction. Finally, the concrete shielding walls that receive the largest amount of radiation may degrade over time or become activated through radiation impingement at the surface. Since the shielding walls are formed from continuously poured concrete, it is not possible to merely replace or repair the outer layer, and reconstruction of the entire wall is required.

An additional problem with facilities constructed from mass concrete pours is the long construction time and the quality assurance measures required to ensure proper shielding. There is also a chance that the selected concrete aggregates could become activated by long term constant exposure to a high energy neutron field. If the concrete is activated to levels that are above the permissible exposure limits, the concrete structure would have to be reconditioned. There are only two ways to deal with this problem, either by removing the activated material and replacing it with new material, or by placing a shield in front of the activated material. Both of these solutions are problematic when working with concrete structures, as concrete cannot be easily removed and replaced. Reinforcing steel bars that provide structural integrity for the concrete are typically placed 4 to 6 inches inwardly of the face of the concrete, which is exposed to the main radiation source and where activation usually occurs. Removing the activated material would require chipping away the face of the concrete with tools such as jack hammers, but doing so could damage the reinforcing steel bars and compromise the structural integrity of the concrete wall.

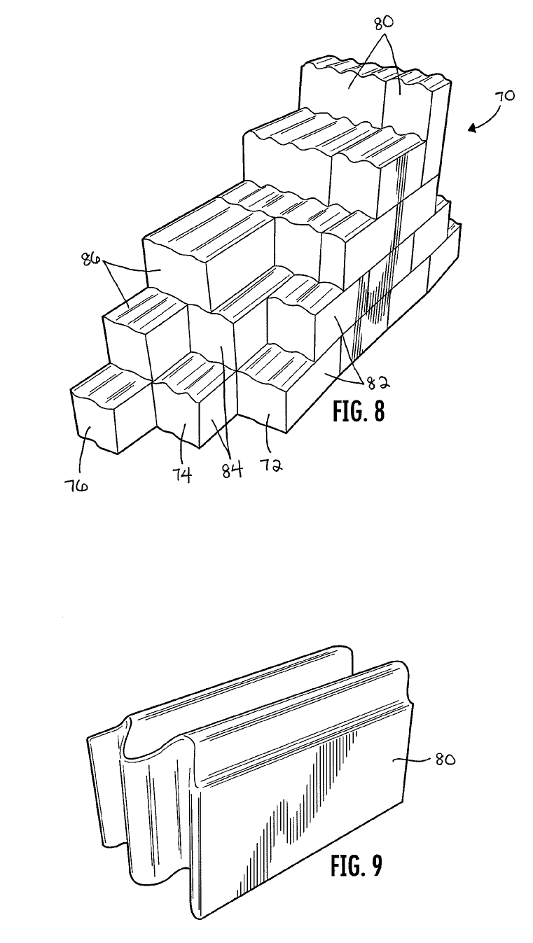

The present application addresses the above disadvantages of traditional concrete shielding walls by using a layered barrier 70 formed from modular shielding elements 80, which are pre-formed, can be easily stored, transported, and are unaffected by weather. As shown in FIGS. 8 and 9, the modular shielding elements 80 are preferably formed with continuously curved surfaces in a “tongue and groove” pattern, which allows the modular shielding elements 80 to interlock in two perpendicular directions and minimizes radiation leakage through seams between adjoining modular shielding elements 80. The materials of the modular shielding elements 80 are selected based on the desired structural and shielding characteristics for the particular particle facility. An example of such a modular shielding element 80 is described in detail in International Appln. No. PCT/US2009/054814 for “Masonry Block With Continuously Curved Surfaces,” which is incorporated by reference as if fully set forth herein.

Unlike traditional concrete shielding walls, which utilize a homogenous concrete mixture with a single shielding characteristic, the present layered barrier 70 is designed to attenuate and/or capture particles at different energy levels, and provide a more efficient and effective solution to radiation shielding. For example, a facility constructed using the present layered barrier 70 can achieve the following shielding design limits. In uncontrolled areas, the average radiation dose can be limited to approximately 2 millirem (mrem)/week after application of Occupancy Factors (T). The lowest Occupancy Factor inside of a building is ¼. With the Occupancy Factor set at 1, the average radiation dose can be limited to 2 mrem/hour in uncontrolled areas, and 10 mrem/week in controlled areas. A roof constructed using the present layered barrier 70 can be limited to 10 mrem/week dose rate and 2 mrem in 1 hour (total dose allowable in any single hour). The average radiation dose in public areas can be limited to less than 2 mrem/week. The present layered barrier 70 can meet these limits while being up to half as thick as a traditional concrete wall to offer the same amount of attenuation.

As shown in FIG. 8, the layered barrier 70 includes a first layer 72 formed from first modular shielding elements 82 and a second layer 74 formed from second modular shielding elements 84. Preferably, the layered barrier 70 is arranged such that the first layer 72 is closest to the radiation source 29, so that the leaked radiation particles contact the first layer 72 before the second layer 74. The first and second shielding elements 82, 84 are modular and have different shielding characteristics from each other. The different modular shielding elements 80 can be color coded or have any other type of distinguishing color, shape, or mark to distinguish the various modular shielding elements 80 from one another. For example, the first modular shielding elements 82 can be a first color and the second modular shielding elements 84 can be a second color.

The different shielding characteristics can be achieved by forming the first and second shielding elements 82, 84 from different materials or different concentrations of materials. For example and without limitation, the first shielding elements 82 can be formed from a metallic aggregate material, such as iron or iron based products, that is suitable for attenuating and slowing down high energy particles. As the high energy particles travel through the first shielding elements 82 of the first layer 72, they lose some of their energy and change into medium energy particles. Accordingly, the second shielding elements 84 of the second layer 74 are preferably formed from a different material tailored for medium energy particles. For example and without limitation, the second shielding elements 84 can be formed from a hydrogenous material, which is suitable for further attenuating and slowing down the medium energy particles. As the medium energy particles travel through the second shielding elements 84 of the second layer 74, some of the particles become slow moving, and scatter from the first and second layers 72, 74. To prevent the scattered particles from bouncing back into the rooms of the compact particle facility, the layered barrier 70 can include a third layer 76 formed from third shielding elements 86, which are modular and have a different shielding characteristic from the shielding characteristics of the first and second shielding elements 82, 84. The third shielding elements 86 of the third layer 76 are preferably formed from a material adapted to capture slow moving particles that scatter from the first and second layers 72, 74. For example, where neutrons are used in the particle facility, the third shielding elements 86 can be formed from boron or lithium based materials, which are suitable for capturing neutron particles and byproducts.

The use of multiple layers allows the present layered barrier 70 to be optimized for specific types of shielding, and for different locations within a facility, as the energy and flux of particles vary depending on the angle and distance at which they meet the shielding wall. Therefore, the composition and number of layers of the layered barrier 70 can be adjusted based on its location in a facility. Such customization results in fewer blocks, thinner walls, and much faster installation in comparison to traditional concrete shielding walls. A facility using the present layered barrier 70 requires 6-9 months less construction time than a comparable facility using traditional concrete walls. As shown in FIG. 8, the first, second, and third layers 72, 74, 76 are arranged adjacent to each other. Specifically, the first layer 72 can be in contact with the second layer 74, which can be in contact with the third layer 76. Alternatively, the first, second, and third layers 72, 74, 76 can be configured so that a single layer can be easily removed without affecting the other layers, in which case the first layer 72 can be associated with the second layer 74 through mechanical fasteners, such as masonry tie straps. The second layer 74 can be similarly associated with the third layer 76. Depending on the shielding needs of the particular particle facility and the type of particles used, the materials and the thicknesses of the first, second, and third layers 72, 74, 76 can be varied. In certain situations, a single layer made of one type of material that is a homogenous combination of various elements may provide sufficient shielding. Although not shown in FIG. 8, the layered barrier 70 can include additional layers formed from the same materials as, or different materials from, the first, second, and third layers 72, 74, 76. The term “layer” as used herein, refers to a portion of a wall made of the same shielding elements and can have a thickness of one modular block or a plurality of modular blocks.

For example, in a compact particle facility utilizing a proton accelerator operating above 10 MeV, neutrons constitute the greatest prompt radiation. The neutron spectra span a wide energy range, from thermal energies to the energy of the accelerated protons. Neutrons are also of concerns for ion accelerators (e.g., C-12 ions). In traditional particle facilities, the neutrons are shielded with concrete walls, sometimes supplement with steel shielding up to 4 feet thick. In the present layered barrier 70, the neutron spectrum is softened through inelastic collisions with high-Z materials used in the modular shielding elements 80 of the layered barrier 70, this inelastic scattering also increases the shielding effectiveness of the hydrogen and other elements in the layered barrier 70. High-Z materials are materials with a high atomic number (i.e., number of protons), such as, for example and without limitation, lead, steel, and tungsten.

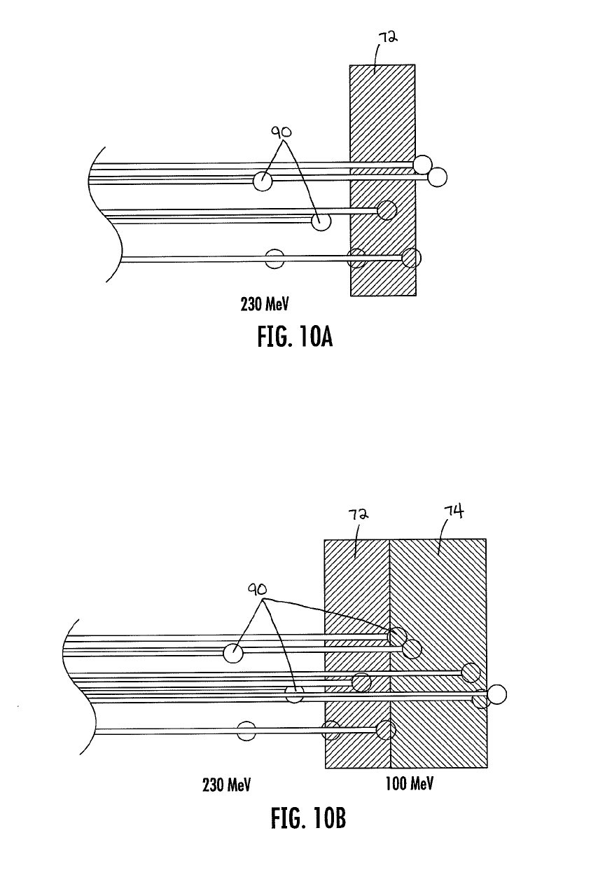

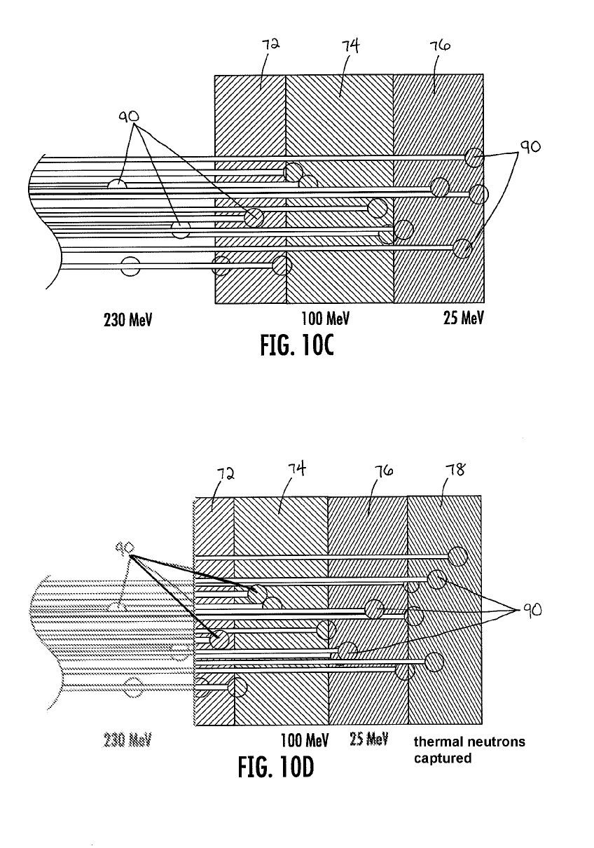

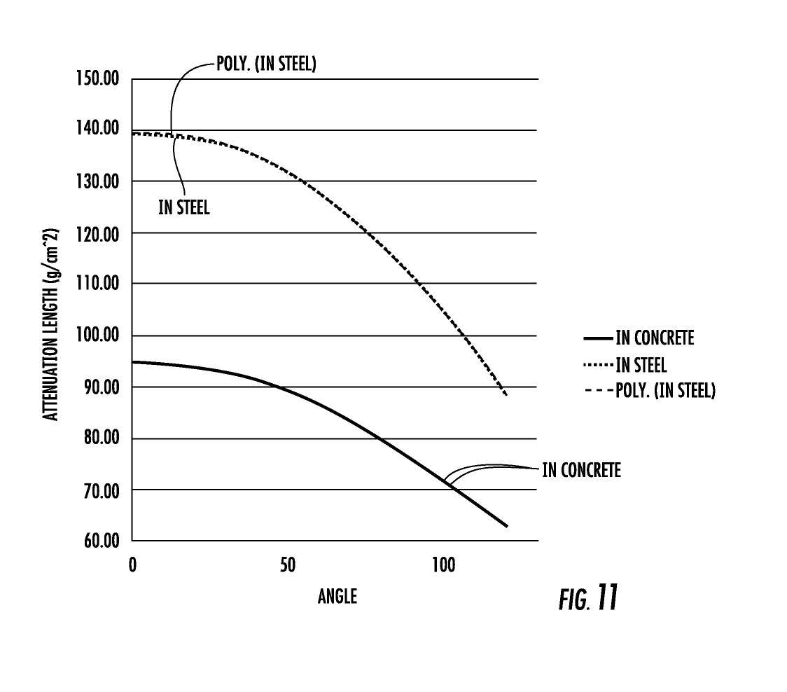

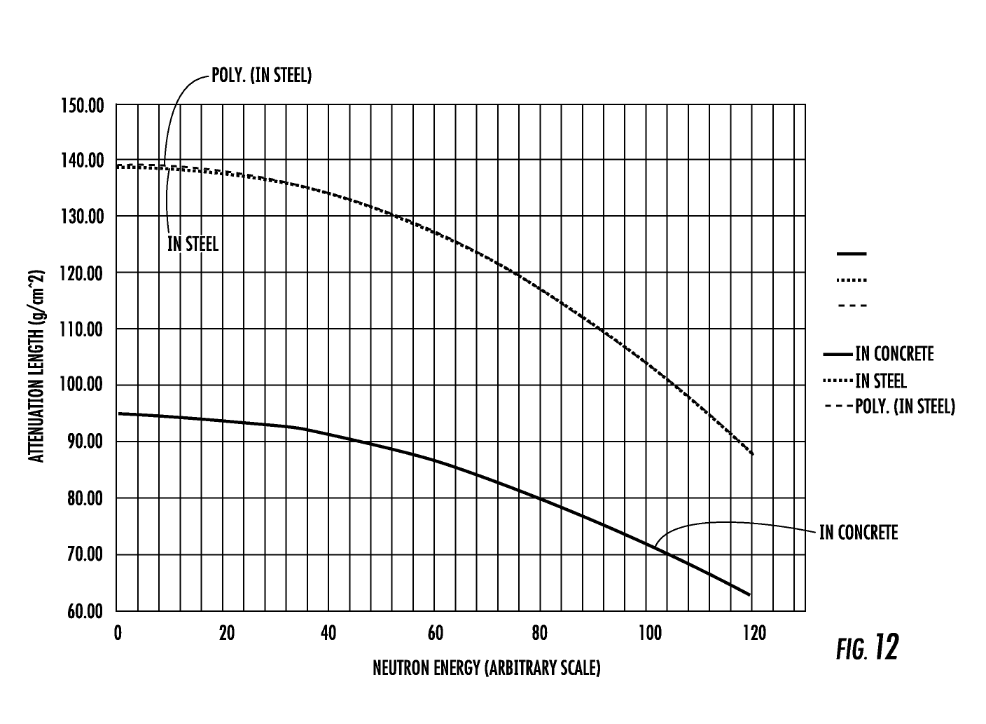

FIGS. 10A-10D illustrate an example of how the present layered barrier 70 is used in neutron shielding. The particles shown in FIGS. 10A-10D are neutrons 90 from a proton facility, which are higher in energy than those from a standard medical linear accelerator. As shown in FIG. 10A, the neutrons 90 of FIGS. 10A-10D can have an energy range of approximately 230 MeV, compared to approximately 20 MeV for those from medical linear accelerators. To properly attenuate such high energy particles, the first layer 72 of the present layered barrier 70 is formed of first shielding elements 82 having materials best suited to neutrons in the 230 MeV energy range, such as a metallic aggregate material. The metallic aggregate material can include high-Z materials, such as, for example and without limitation, lead, steel, and tungsten. As shown in FIG. 10B, after moving through the first layer 72, the energy range of the neutrons 90 drops to approximately 100 MeV. The second shielding elements 84 of the second layer 74 is formed of a material having high “Z” aggregates and high hydrogen content. The densities of the first and second shielding elements 82, 84 of the first and second layers 72, 74 are important for degrading the energy of the neutrons 90. FIG. 10C shows a further drop in energy to approximately 25 MeV as the neutrons 90 move past the second layer 74 and approach its thermal equilibrium phase. The third shielding elements 86 of the third layer 76 are formed of a material having high hydrogen content. If the third layer 76 is the last layer of the layered barrier 70, the material of the third shielding elements 86 should also include materials having a high macroscopic neutron cross-section to capture the neutrons 90, specifically thermal neutrons, and having sufficient density to capture the byproduct gamma radiation. Suitable material include, for example and without limitation, boron, lithium, cadmium, steel, and carbon. FIG. 10D shows an optional fourth layer 78 to aid with capturing the neutrons 90 and the resulting gamma radiation. Like the third layer 76, where the optional fourth layer 78 is the last layer of the layered barrier, the fourth layer 78 should have sufficient density and include aggregates having a high macroscopic neutron cross-section to capture thermal neutrons.

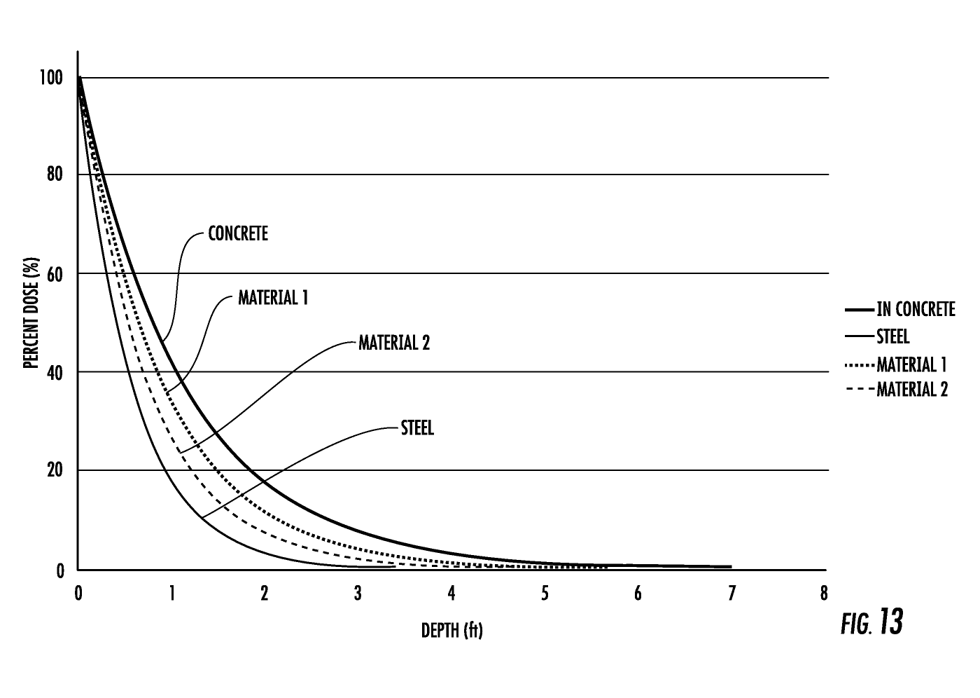

The attenuation of particles is proportional to the density of the shielding material and inversely proportional to the attenuation length. The graph shown in FIG. 11 illustrates attenuation length comparisons of different materials for different materials at various angles. The graph shown in FIG. 12 illustrates attenuation length comparisons of different materials at different neutron energies.

In another example, a ProTom International synchrotron accelerator was used to direct protons having an energy of 230 MeV at a copper target to produce neutrons. The beam on target position on the copper target was verified with gafchromic film. A WENDI neutron detector, operating in integration mode, was shielded from five sides with one side open to detect neutrons from the radiation source at a set angle as the neutrons passed through the shielding stack. In medical applications, the radiation used typically consists of 70% high energy radiation to treat deep seated tumors, such as prostate tumors, and 30% low energy radiation to treat shallow tumors. For the present test, a combination of 50% high energy radiation and 50% low energy radiation was assumed. Energy and range verification measurements were performed with a PTW Markus chamber and CRS phantom and electrometer. The requested proton range was verified to be accurate at less than 1 mm level. The shielding radiation field is dominated by neutrons. The neutron fields produced by proton losses consist of cascade neutrons and evaporation neutrons. Evaporation neutrons can have energies up to 8 MeV with evaporation spectrum described by Weisskopf's formula, in which τ is a so-called nuclear temperature of the order of 2-10 MeV:

N(E)dE∝Eexp(−E/τ)dE

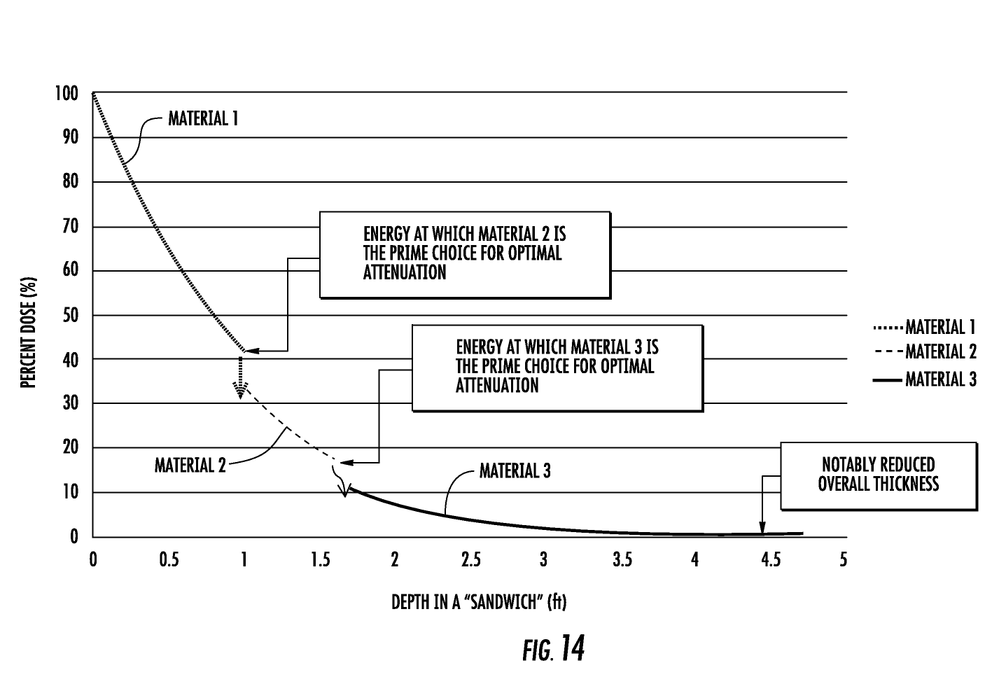

Evaporation neutrons have isotropic angular distribution and dominate the total neutron yield from a target stuck by protons at lower energies. However, their contribution to the total neutron yield decreases with decreasing angle with respect to the proton beam and with increasing incident proton energy. It was shown in both calculations and measurements that evaporation neutron yield is significantly higher from high Z targets, with dose equivalent difference reaching up to a factor of 16 between carbon and lead targets. High Z targets are made from materials having a high atomic number, such as, for example and without limitation, copper, aluminum, titanium, and brass. Cascade neutrons have energies greater than 8 MeV, and are forward peaked. The yield of cascade neutrons increases with increasing incident proton energy, and both calculations and measurements revealed that cascade neutrons production is nearly independent of the target material, with slightly increasing dose equivalent from heavier targets in a lateral direction. In the present test, neutron attenuation lengths were derived for the present layered barrier 70 using modular shielding elements 80 formed from different materials, and compared with the performance of traditional concrete blocks. Testing was conducted in both a forward direction and a 60° direction. The attenuation properties of various sandwiched combinations were characterized. As shown in the graphs of FIGS. 13 and 14, several materials performed markedly better than concrete blocks. The extent of the enhancement of the attenuation properties per unit length of the modular shielding elements 80 was the greatest when the modular shielding elements 80 were used in a specific order in a sandwich combination as previously discussed in the present application.

A compact particle facility constructed using the present layered barrier 70 is also disclosed. The compact particle facility preferably includes one or more treatment rooms. A radiation source can be located directly within in each treatment room. Alternatively, the one or more treatment rooms can be supplied with radiation from a single radiation source located in a separate room outside of the treatment rooms. One of ordinary skill in the art will understand that the layered barrier 70 of the present application can be used as a wall, ceiling, door, or other shielding element, and in any particle facility, not merely the compact particle facilities shown in FIGS. 2-7.

A method of constructing a compact particle facility using the present layered barrier 70 is also disclosed. The method includes the steps of providing the first layer 72 formed from first shielding elements 82, and providing the second layer 74 formed from second shielding elements 84 adjacent to the first layer 72, as shown in FIG. 8. The method can further include the step of providing the third layer 76 formed from the third shielding elements 86 adjacent to the second layer 74. Because of the different shielding characteristics of the first, second, and third modular shielding elements 82, 84, 86, the resulting layered barrier 70 can effectively attenuate and capture radiation leak and particle byproducts.

FIG. 2 shows a first embodiment of a compact particle facility 30 constructed using the present layered barrier 70. The compact particle facility 30 includes a plurality of separate rooms 34, each with a maze entry 36 having a wing wall 38 to capture scatter radiation from the radiation source 29. As shown by the shaded area in FIG. 2 outside of the walls of the compact particle facility 30, the present compact particle facility 30 has space saving advantages even when maze entries 36 are used. This reduction in footprint is due to decreased thickness of the ceilings, floors, and walls, which can each be formed from the present layered barrier 70 shown in FIGS. 8 and 9. A traditional radiation room has wall and ceiling thicknesses of 8-20 feet or more. The present compact particle facility 30 can be constructed with significantly reduced wall and ceiling thicknesses while achieving the same or greater level of radiation shielding. As discussed above with respect to FIGS. 8-10D, the present layered barrier 70 allows for customization of shielding characteristics. The present layered barrier 70 is further advantageous over poured concrete barriers because concrete is made up of a combination of aggregate materials, some of which may be more prone to activation. In contrast, the present modular shielding blocks 80 are manufactured specifically for the intended application and their composition is engineered to minimize or eliminate any activation possibility. In either event, if the layered barrier 70 were to become activated over time, it can be easily remediated by removing and replacing the activated modular shielding blocks 80 in the initial layers in the first few inches or feet of the layered barrier 70. In poured concrete barriers, removal is nearly impossible.

In addition to the space saving and shielding advantages discussed above, the use of modular shielding elements 80 also allows the present compact particle facility 30 to be modular and easily expandable or configurable. Unlike traditional particle facilities 20 with walls poured from concrete or constructed from mortared concrete blocks, the present compact particle facility 30 constructed from layered barriers 70 made up of modular shielding elements 80 can be easily expanded or configured by modifying, for example and without limitation, the number of rooms 34, the shape of the rooms 34, the amount of shielding, or the type of shielding. The modular nature of the present compact particle facility 30 also allows the rooms 34 to be constructed on more than one floor, whereas traditional particle facilities 20 usually require all rooms 24 to be located on the ground floor. The present compact particle facility 30 is also easily constructed, as the modular shielding elements 80 are easily transported to the worksite, can be stored indoors or out, and are unaffected by weather. In addition, the construction of the compact particle facility 30 can be automated by using, for example, a programmed robotic arm to stack the modular shielding elements 80 according to a floor plan.

FIG. 3 shows a second embodiment of a compact particle facility 40 constructed using the present layered barrier 70. The compact particle facility 40 includes a plurality of rooms 44, each one of the rooms 44 having a plurality of layered barriers 70 that define an interior area 46 that is directly accessible through a shielded door 48 instead of a maze entry. The ceiling, floor, walls, and shielded door 48 of the compact particle facility 40 can each be formed from the present layered barrier 70 as discussed above with respect to FIGS. 8-10D to prevent radiation from escaping to the outside of the rooms 44. As shown by the shaded area in FIG. 3 outside of the walls of the compact particle facility 40, the compact particle facility 40 having a direct entry 49 has an even smaller footprint than the compact particle facility 30 having a maze entry 36 shown in FIG. 2. The use of a sufficiently shielded door 48 eliminates the additional space required to form a maze entry 36, thus offering significant space savings and ease of access. An example of a motor driven shielded door 48 is disclosed in U.S. Patent Appln. No. 61/319,718, which is incorporated as if fully set forth herein.

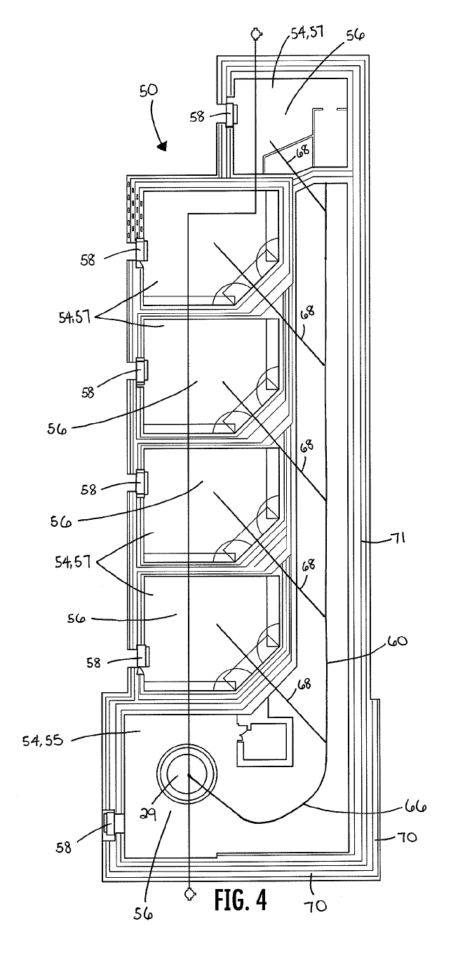

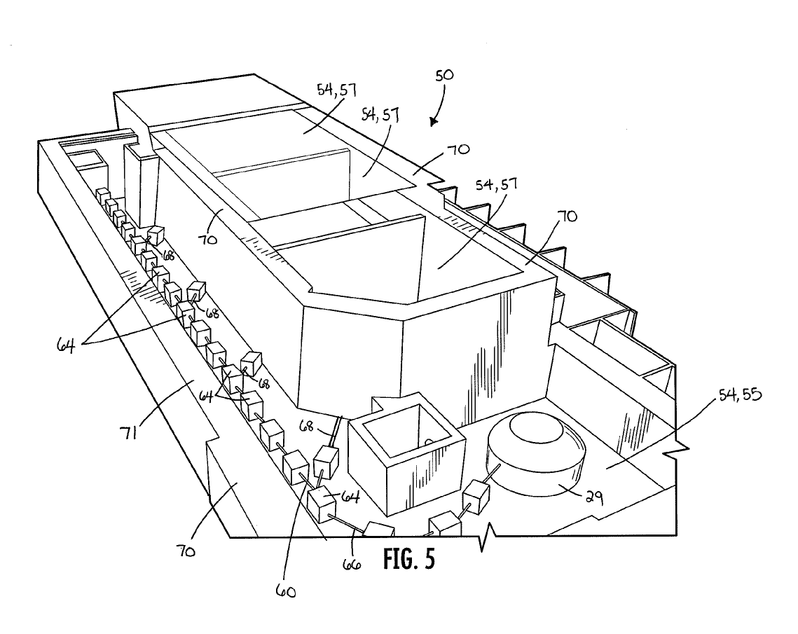

FIGS. 4 and 5 show a third embodiment of a compact particle facility 50 constructed using the present layered barrier 70. The compact particle facility 50 includes a plurality of rooms 54, each one of the rooms 54 having a plurality of layered barriers 70 that define an interior area 56 that is directly accessible through a shielded door 58. A single radiation source 29, such as a particle linear accelerator, is located in a radiation source room 55 and directs radiation to the treatment rooms 57 through a wave guide 60. This configuration can be especially advantageous where the compact particle facility 50 is a medical treatment facility, as radiation therapy can be provided to individual treatment rooms 57 without the patients being present in the same room as the radiation source 29. The compact particle facility 50 according to this embodiment also includes the advantages discussed above with respect to FIGS. 2-3 and 8-10D, including the reduction in footprint, ease of construction, expandability, and configurability.

As shown in FIG. 5, a plurality of magnets 64 are preferably arranged at regular intervals along the wave guide 60 to direct the path of the particles as they travel from the radiation source 29 into the treatment rooms 57. As the particles travel along the wave guide 60, some of the particles escape the path of the wave guide 60 in the form of leaked radiation. Therefore, the outer walls of the compact particle facility 50 can be formed from the present layered barrier 70 to prevent radiation leakage to the outside. As shown in FIGS. 4 and 5, the wave guide 60 can have a curved portion 66 in the area between the radiation source 29 and a first treatment room 57. Due to the proximity to the radiation source 29 and the curvature of the wave guide 60, the curved portion 66 of the wave guide 60 typically has the largest radiation loss. Therefore, a first layered barrier 70 surrounding the curved portion 66 of the wave guide 60 preferably includes the first, second, and third layers 72, 74, 76 to ensure adequate particle attenuation and capture. As the particles travel past the curved portion 66 of the wave guide 60 and are directed to the individual treatment rooms 57 through branched portions 68 of the wave guide 60, the radiation loss decreases as a function of the increased distance from the radiation source. Therefore, a second layered barrier 71 having a decreased thickness can be used in those areas. Unlike the first layered barrier 70, the second layered barrier 71 may only include the second and third layers 74, 76, which are tailored to attenuate and capture medium and low energy particles. Furthermore, depending on the layout of the particular particle facility, there may be areas where only the third layer 76 is needed. Using a variety of layered barriers having different numbers of layers in a particle facility further decreases the footprint of the facility and saves construction costs and time.

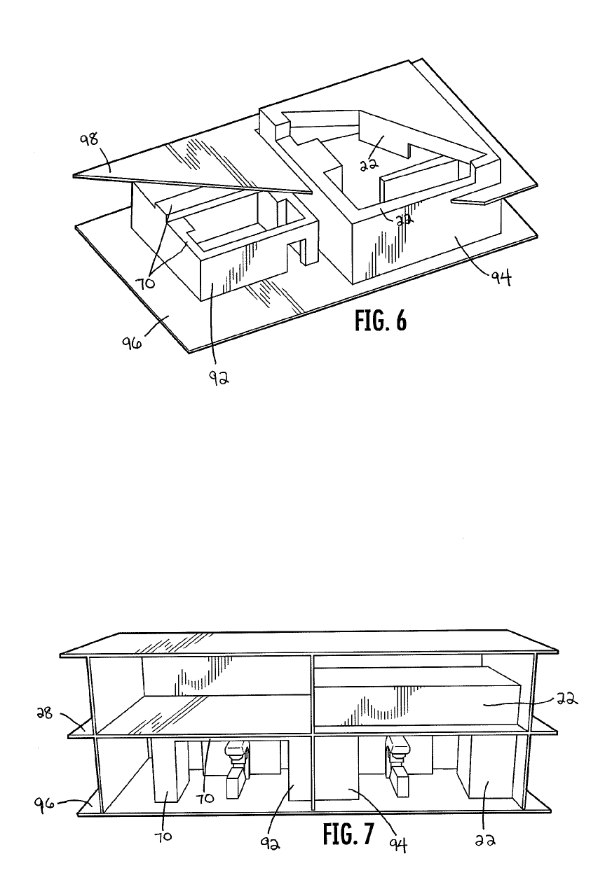

FIGS. 6 and 7 show a comparison of a first particle facility room 92 constructed from the layered barrier 70 of the present application and a second particle facility room 94 constructed from conventional concrete shielding barriers 22. As shown in the comparison, the use of layered barriers 70 formed of modular shielding elements 80 significantly decreases wall thickness, the footprint of the facility, and the height of the rooms, while increasing the amount of useable space within the facility. As shown in FIGS. 6 and 7, the first and second particle facility rooms 92, 94 are both constructed from the ground floor 96. Whereas the second particle facility room 94 having concrete shielding barriers 22 requires an extremely thick ceiling that extends into the second floor 98, the first particle facility room 92 having layered barriers 70 does not extend into the second floor 98, thus leaving that space free for use. Therefore, construction of a compact particle facility using the layered barrier 70 of the present application has significant space saving advantages over traditional concrete shielding barriers. For example, construction of the compact particle facility shown in FIGS. 4 and 5 with concrete shielding barriers would require over 17,000 square feet of space, with only approximately 8,000 square feet of usable space. In contrast, construction of the same compact particle facility 50 using the present layered barriers 70 can reduce the overall space by approximately 5,000 square feet, while increasing the useable space by over 1,000 square feet. In comparison to traditional concrete shielding barriers, the present layered barriers 70 can achieve 45-55% reduction in thickness while maintaining comparable shielding characteristics.

In addition to the space and cost saving advantages, the layered barrier 70 of the present application is further advantageous in that it allows for easy repair or replacement of any one of the first, second, and third layers 72, 74, 76 without having to replace the entire barrier, as is the case with continuously poured concrete barriers. As the first layer 72 of the layered barrier 70 degrades overtime due to exposure to radiation, the first layer 72 can be easily replaced, leaving the second and third layers 74, 76 in place for structural support. In addition, if a different type of particle is used in the particle facility, the layered barrier 70 can be reconfigured to provide proper shielding for the new particle by merely switching out the modular shielding elements 80 used to form the layers of the layered barrier 70. This process is significantly less costly and time consuming than rebuilding the barriers of the particle facility, which would be required if concrete shielding barriers were used. Furthermore, since the modular shielding elements 80 of the layered barrier 70 are manufactured in a controlled factory environment using materials for which the activation or non-activation properties are well known, it is possible to ensure at the outset that materials which are highly susceptible to induced radioactivity are not used in the modular shielding elements 80. This is not the case with concrete suppliers, who may purchase concrete aggregates from various locations in the country and may be unaware of activation problems that can occur by using the wrong aggregates. Moreover, quality assurance procedures used for concrete generally only focus on density and strength characteristics as the concrete is being placed, and there is no way to determine at the construction site what aggregates are in the web concrete mixture when it arrives. Because the modular shielding elements 80 are manufactured well before they are used to construct the layered barrier 70, there is plenty of time before construction for investigative measures to ensure that the modular shielding elements 80 meets the requisite design specifications.

Various methods, configurations, and features of the present application having been described above and shown in the drawings, one of ordinary skill in the art will appreciate from this disclosure that any combination of the above features can be used without departing from the scope of the present application. It is also recognized by those skilled in the art that changes may be made to the above described methods and embodiments without departing from the broad inventive concept thereof.

What is claimed is:

1. A layered barrier for a compact particle facility having a radiation source emitting radiation, the layered barrier comprising a first layer formed from first shielding elements having a metallic aggregate material and a second layer formed from second shielding elements having a hydrogenous material, wherein the first shielding elements are incident to the radiation emitted from the radiation source and the first and second shielding elements are modular and have different shielding characteristics from one another.

2. The layered barrier of claim 1, further comprising a third layer formed from third shielding elements, wherein the third shielding elements are modular and have a different shielding characteristic from the shielding characteristics of the first and second shielding elements.

3. The layered barrier of claim 2, wherein the third shielding elements are formed of a different material from the materials of the first and second shielding elements.

4. The layered barrier of claim 3, wherein the third shielding elements are formed of a material adapted to capture particles.

5. The layered barrier of claim 2, wherein the first layer is arranged adjacent to the second layer, which is arranged adjacent to the third layer.

6. The layered barrier of claim 5, wherein the first layer is in contact with or otherwise associated with the second layer, which is in contact with or otherwise associated with the third layer.

7. A compact particle facility comprising a room having a plurality of layered barriers that define an interior area that is directly accessible through a shielded door located in one of the plurality of layered barriers, each one of the plurality of layered barriers being formed from modular shielding elements.

8. The compact particle facility of claim 7, wherein the plurality of layered barriers comprise side walls of the room.

9. The compact particle facility of claim 7, wherein the plurality of layered barriers comprise a ceiling of the room.

10. The compact particle facility of claim 7, wherein the shielded door is formed from modular shielding elements.

11. The compact particle facility of claim 7, further comprising a radiation source located in the interior area.

12. The compact particle facility of claim 11, wherein the plurality of layered barriers and the shielded door prevent substantially all radiation from the radiation source from leaving the room.

13. The compact particle facility of claim 7, wherein each one of the plurality of layered barriers includes a plurality of layers, each one of the plurality of layers being formed from a different material having a different shielding characteristic.

14. A compact particle facility comprising a source room and at least one patient room, the source room and the at least one patient room each having a plurality of layered barriers that define an interior area that is directly accessible through a shielded door located in one of the plurality of layered barriers, each one of the plurality of layered barriers being formed from modular shielding elements, wherein the source room contains a radiation source and radiation from the radiation source is directed into the at least one patient room through a wave guide.

15. The compact particle facility of claim 14, further comprising two patient rooms that receive radiation from the source room by the wave guide.

16. The compact particle facility of claim 14, wherein each one of the plurality of layered barriers includes a first layer and a second layer, the first layer and the second layer being formed from different materials having different shielding characteristics from each other.

17. The compact particle facility of claim 16, wherein the first layer of each one of the plurality of layered barriers is formed of a material adapted to slow down high energy particles, and the second layer of each one of the plurality of layered barriers is formed of a material adapted to slow down medium energy particles.
